(19) United States
(12) Patent Application Publication
(10) Pub. No.: US 2026/0327449 A1
(43) Pub. Date: Oct. 22, 2026

(54) FLUOROPOLYMER DISPERSION COMPOSITIONS AND METHODS FOR REDUCING VISCOSITY

(71) Applicant: DUPONT ELECTRONICS, INC., Wilmington, DE (US)

(72) Inventors: Michael Thomas DEMKO, Wilmington, DE (US); Yiyuan YIN, Wilmington, DE (US); Donald MAY, Wilmington, DE (US); Brian M. FISH, Wilmington, DE (US)

(21) Appl. No.: 19/122,570

(22) PCT Filed: Oct. 24, 2023
(86) PCT No.: PCT/US2023/077648

§ 371 Date: Apr. 18, 2025

Related U.S. Application Data
(60) Provisional application No. 63/420,211, filed on Oct. 28, 2022.

(51) Int. Cl. C09D 127/14; C08J 5/18; C09D 7/20; C09D 7/48; C09D 7/61; C09D 7/63; C09D 7/65

(52) U.S. Cl. CPC C09D 127/14; C08J 5/18; C09D 7/20; C09D 7/48; C09D 7/61; C09D 7/63; C09D 7/65; C08J 2327/14

(57) ABSTRACT

A fluoropolymer dispersion composition, comprising a fluoropolymer comprising a poly(vinyl fluoride) homopolymer or a poly(vinyl fluoride) copolymer; a latent solvent; and 0.05 weight percent (wt %) to 10 wt %, preferably 0.05 wt % to 5 wt %, more preferably 0.2 wt % to 2.0 wt % of an aqueous additive composition, based on a total weight of the fluoropolymer dispersion composition, wherein the fluoropolymer dispersion composition has a viscosity at 25° C. that is less than a viscosity at 25° C. of a comparable fluoropolymer dispersion composition that comprises the fluoropolymer and the latent solvent, wherein the comparable fluoropolymer dispersion composition does not comprise the aqueous additive composition.

### CROSS-REFERENCE TO RELATED APPLICATION

The present application claims priority under 35 U.S.C. § 365 (c) to U.S. Provisional Appln. No. 63/420,211, filed on Oct. 28, 2022, which is incorporated herein by reference in its entirety.

### FIELD OF THE INVENTION

Provided herein is a fluoropolymer dispersion composition comprising an aqueous additive. The fluoropolymer dispersion is characterized by favorable rheological properties, in particular, reduced viscosity and thixotropy compared to a comparable fluoropolymer dispersion that does not contain the aqueous additive. Further provided herein is a fluoropolymer coating composition comprising the fluoropolymer dispersion composition.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Coatings made from fluoropolymer dispersions are known to exhibit outdoor durability, chemical resistance, and acceptable mechanical properties. The performance features of coatings made from fluoropolymer dispersions have led to their extensive use, for example, in the exterior building panel market. Coatings made from fluoropolymer dispersions are often applied by spray and roll coating or coil coating of flat sheet stock techniques. The coating film is formed by thermal fusion of the fluoropolymer particles in admixture with a latent solvent.

When coating fluoropolymer dispersions on a metal coil, a roller is used to pick up the paint from a pan and then coat onto a metal web. To achieve a sufficiently high wet-film-thickness, a sufficiently high viscosity is needed at a high shear rate together with a sufficiently high solids content in the liquid coating. These application rollers lay down small bands of paint, 0.5 mm apart. After coating, these bands must level out to form a smooth surface with a minimum of lines and ridges. This leveling flow occurs at low shear rate, generally driven by surface tension and surface viscosity. In general, to achieve the best paint coverage of a metal coil, a paint should have a minimum of thixotropy.

Current fluoropolymer coatings formulated without any thixotropy controlling additives have very high viscosity at low shear rate. This prevents them from leveling out after coating and results in a “ropey” coating appearance. Adding additional solvent can lower the viscosity at low shear rate and therefore improve leveling but will also reduce viscosity at high shear rate and lower percent solids thereby preventing the coater from achieving the proper wet film thickness. Adding solvent also reduces the solids content of the coating and may hinder the ability to obtain adequate coating thickness. Excess solvent dilution also results in the creation of more waste solvent to recover or dispose.

Accordingly, there remains a continuing need for fluoropolymer dispersion coatings and paints having a lower viscosity without the use of organic solvents to achieve that result.

### BRIEF DESCRIPTION OF THE INVENTION

Accordingly, provided herein is a fluoropolymer dispersion composition including a fluoropolymer including a poly(vinyl fluoride) homopolymer or a poly(vinyl fluoride) copolymer; a latent solvent; and 0.05 weight percent (wt %) to 10 wt %, preferably 0.05 wt % to 5 wt %, more preferably 0.2 wt % to 2.0 wt % of an aqueous additive composition, based on a total weight of the fluoropolymer dispersion composition, wherein the fluoropolymer dispersion composition has a viscosity at 25° C. that is less than a viscosity at 25° C. of a comparable fluoropolymer dispersion composition that comprises the fluoropolymer and the latent solvent, wherein the comparable fluoropolymer dispersion composition does not include the aqueous additive composition.

Further provided is a coated substrate including the composition disposed on at least a portion of at least one side of a substrate.

Still further provided is a cured film derived from the composition or the coated substrate, wherein the cured film is prepared by casting the composition on a polymer film, heating the cast composition to form a cohesive film, and removing the cohesive film from the polymer film to provide the film. When a crosslinking agent is present in the fluoropolymer coating composition, the cohesive film is also cured during the heating step.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. 1 is a graph of thixotropy (1 rpm/100 rpm) versus the amount of water additive (wt %), and a bar graph of viscosity (centipoise, cPs) versus the amount of water additive (wt %), showing the results from Example 1 and Table 1.

FIG. 2 is a graph of thixotropy (1 rpm/100 rpm) versus the amount of water additive (wt %), and a bar graph of viscosity (cPs) versus the amount of water additive (wt %), showing the results from Comparative Example 1 and Table 2.

FIG. 3 is a graph of thixotropy (1 rpm/100 rpm) versus pH, and a bar graph of viscosity (cPs) versus pH, showing the results from Example 2 and Table 4.

FIG. 4 is a graph of thixotropy (1 rpm/100 rpm) versus acid source, and a bar graph of viscosity (cPs) versus acid source, showing the results from Example 3 and Table 5.

FIG. 5 is a graph of thixotropy (1 rpm/100 rpm) versus the amount of water (wt %), and a bar graph of viscosity (cPs) versus the amount of water additive (wt %), showing the results from Example 4 and Table 6.

FIG. 6 is a graph of thixotropy (1 rpm/100 rpm) versus the amount of polyvinyl fluoride (PVF) dispersion (wt %), and a bar graph of viscosity (cPs) versus the amount of PVF dispersion (wt %), showing the results from Example 5 and Table 7.

### DETAILED DESCRIPTION

Reference will now be made in detail to exemplary embodiments, examples of which are illustrated in the present description. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Fluoropolymer dispersions are useful for creating articles from a polymer powder, generally by fusing particles into the article using a suitable latent solvent. Higher solids content dispersions are useful to maximize productivity of the dispersions, but can exhibit high viscosity and thixotropy at higher solids. Therefore, 50 wt % or greater of organic solvent is often used to reduce the viscosity in order to facilitate application of the fluoropolymer dispersion coatings to a substrate. The present inventors have surprisingly discovered that including a specific amount of an aqueous additive composition in a poly(vinyl fluoride) polymer dispersion, for example an aqueous additive composition that includes water, can provide for a reduced viscosity and thixotropy that exceeds any dilution effects that would have been expected based on the addition of the aqueous additive composition. Accordingly, the inventive compositions described herein may achieve a reduced viscosity and a reduced thixotropy, use less organic solvent, and improve the leveling performance of coatings made with the fluoropolymer dispersion.

Provided herein is a fluoropolymer dispersion composition including a fluoropolymer comprising a poly(vinyl fluoride) homopolymer or a poly(vinyl fluoride) copolymer; a latent solvent; and 0.05 weight percent (wt %) to 10 wt %, preferably 0.05 wt % to 5 wt % of an aqueous additive composition, based on the total weight of the fluoropolymer dispersion composition. The fluoropolymer dispersion composition has a viscosity at 25° C. that is less than a viscosity at 25° C. of a comparable fluoropolymer dispersion composition, wherein the comparable fluoropolymer dispersion composition includes the fluoropolymer and the latent solvent, and wherein the comparable fluoropolymer dispersion composition does not include the aqueous additive composition. In some aspects, the fluoropolymer dispersion composition has a thixotropy at 25° C. that is less than a thixotropy at 25° C. of a comparable fluoropolymer dispersion composition that comprises the fluoropolymer and the latent solvent, wherein the comparable fluoropolymer dispersion composition does not comprise the aqueous additive composition. For example, the fluoropolymer dispersion composition may have a viscosity at 25° C. that is less than a viscosity at 25° C. of a comparable fluoropolymer dispersion composition, and the fluoropolymer dispersion composition may have a thixotropy at 25° C. that is less than a thixotropy at 25° C. of a comparable fluoropolymer dispersion composition that comprises the fluoropolymer and the latent solvent, wherein the comparable fluoropolymer dispersion composition does not comprise the aqueous additive composition.

The fluoropolymer dispersion composition includes a fluoropolymer including a poly(vinyl fluoride) homopolymer or a poly(vinyl fluoride) copolymer. Examples of suitable copolymers include those having at least 60 mole percent (mol %), such as 70 mol %, 80 mol %, or 90 mol %, or more of vinyl fluoride repeating units, based on 100 mol % of total repeating units of the fluoropolymer. Examples of suitable co-monomers to be copolymerized with the vinyl fluoride include ethylene, propylene, isobutylene, styrene, vinyl chloride, vinylidene chloride, difluorochloroethylene, tetrafluoromethylene, chlorotrifluoroethylene, hexafluoropropylene, trifluoroethylene, hexafluoroisobutylene, perfluorobutyl ethylene, perfluoro (propyl vinyl ether), perfluoro(methyl vinyl ether), perfluoro-2,2-dimethyl-1,3-dioxole, perfluoro-2-methylene-4-methyl-1,3-dioxolane, vinyl formate, vinyl acetate, vinyl propionate, vinyl butyrate, (meth)acrylic acid or a salt thereof, methyl (meth)acrylate, allyl (meth)acrylate, acrylonitrile, methacrylonitrile, N-butoxymethylacrylamide, allyl acetate, isopropenyl acetate, or a combination thereof. As used herein, “(meth)acrylic” and like terms are intended to include both acrylic and methacrylic.

In one or more embodiments, the poly(vinyl fluoride) (PVF) may be Tedlar® TPVF 116, which is commercially available from DuPont de Nemours, Inc., of Wilmington, DE.

The fluoropolymer may be in the form of solid dispersible particles. The particle size of the dispersible fluoropolymer particles may be, in some embodiments, less than 20 microns, or preferably less than 10 microns.

The fluoropolymer may be present in the fluoropolymer dispersion composition in an amount of from 50 wt % to 95 wt %, preferably 70 or 75 wt % to 95 wt %, more preferably 80 wt % to 95 wt %, based on the total solids of the fluoropolymer dispersion composition. It will be understood that the solids content, or total solids, includes the fluoropolymer and other non-solvent components, if any, that are included in the fluoropolymer dispersion composition.

As previously indicated, the fluoropolymer dispersion compositions also include a latent solvent. PVF is generally not soluble at room temperature in conventional solvents, however, it can be put into solution with so-called latent solvents. The term “latent solvent” as used herein is defined as an organic liquid, chemically inert with respect to poly(vinyl fluoride), and having no significant solvent or swelling action on poly(vinyl fluoride) at room temperature but being capable at an elevated temperature below its normal boiling point of solvent action sufficient to cause poly(vinyl fluoride) particles to coalesce. The latent solvent need not be a liquid at room temperature. For example, a dispersion of PVF powder may be suspended in a latent solvent and heated to a first temperature at which a gel is formed and then to a higher second temperature at which a solution is formed. Latent solvents and other technology useful in handling PVF are described in U.S. Pat. Nos. 2,953,818 and 3,139,470.

Examples of suitable latent solvents include, but are not limited to, gamma-butyrolactone, N,N-dimethylacetamide, N,N-dimethylformamide, dimethylsulfoxide, N-methyl-2-pyrrolidone, gamma-valerolactone, butadiene cyclic sulfone, tetramethylene sulfone, dimethyl sulfolane, hexamethylenesulfone, diallyl sulfoxide, dicyanobutene, adiponitrile, ethylene carbonate, propylene carbonate, 1,2-butylene carbonate, 2,3-butylene carbonate, isobutylene carbonate, trimethylene carbonate, N,N-diethylformamide, N,N-dimethyl-gamma hydroxyacetamide, N,N dimethyl gamma hydroxybutyramide, N,N-dimethylacetamide, N,N-dimethylmethoxyacetamide, N-methylacetamide, N-methylformamide, N,N-dimethylaniline, N,N-dimethylethanolamine, 2-piperidone, N-methyl-2-piperidone, 1-ethyl-2-pyrrolidone, N-isopropyl 2 pyrrolidone, S-methyl 2 pyrrolidone, beta-propiolactone, delta-valerolactone, alpha-angelica lactone, beta-angelica lactone, epsilon-caprolactone, alpha, beta and gamma-substituted alkyl derivatives of gamma-butyrolactone, gamma-valerolactone, delta-valerolactone, delta-substituted alkyl derivatives of delta-valerolactone, tetramethyl urea, 1-nitropropane, 2-nitropropane, acetonyl acetone, acetophenone, acetyl acetone, cyclohexanone, diacetone alcohol, dibutyl ketone, isophorone, mesityl oxide, methylamyl ketone, 3-methyl-cyclohexanone, bis-(methoxymethyl) uron, methyl acetylsalicylate, diethyl phosphate, butyl carbitol, dimethyl phthalate, diethyl phthalate, ethyl acetoacetate, methylbenzoate, methylene diacetate, methyl salicylate, phenyl acetate, triethyl phosphate, tris(morpholino) phosphine oxide, N-acetylmorpholine, N-acetylpiperidine, isoquinoline, quinoline, pyridine, xylene, tris(dimethylamido) phosphate, or a combination of two or more thereof. In one or more embodiments, the latent solvent may include propylene carbonate, γ-butyrolactone, n-methyl pyrrolidone, dimethylacetamide, dimethylsulfoxide, isophorone, diethyl phthalate, dimethyl phthalate, dimethylformamide, or a combination of two or more thereof.

In one or more embodiments, the latent solvent may be mixed with another organic solvent to form a solvent system. For example, the additional organic solvent may include ethylene glycol monobutylether, butyl carbitol, dipropylene glycol butyl ether, propylene glycol methyl ether acetate (PMA), dibasic ester (DBE), toluene, xylene, trimethyl benzene, methylethylketone, or a combination of two or more thereof.

The latent solvent and the optional additional organic solvent, if any, may be present in an amount of from 30 wt % to 70 wt %, preferably from 35 wt % to 70 wt %, more preferably from 40 wt % to 70 wt %, based on the total weight of the fluoropolymer dispersion composition. Accordingly, the fluoropolymer dispersion composition may have a solids content, or total solids, of from 30 wt % to 70 wt %, or from 30 wt % to 65 wt %, or from 30 wt % to 60 wt %, based on the total weight of the fluoropolymer dispersion composition.

The form of the fluoropolymer in the fluoropolymer dispersion composition is dependent upon the type of fluoropolymer and the latent solvent that are used. For example, the rheological effects described herein are observed in the fluoropolymer dispersion compositions, but not in fluoropolymer gels or solutions. In one or more embodiments, suitable coating formulations are prepared using dispersions of the fluoropolymer. The preparation of these dispersions and coating formulations is described in detail in U.S. Pat. Nos. 2,419,008; 2,510,783; and 2,599,300.

The fluoropolymer dispersion composition also includes the aqueous additive composition. In some embodiments, the aqueous additive composition may include water, for example deionized water. For example, the aqueous additive composition may consist essentially of water, or the aqueous additive composition may consist of water.

The aqueous additive composition is included in the fluoropolymer dispersion composition in an amount from 0.05 wt % to 5 wt %, preferably 0.05 wt % to 5 wt %, more preferably 0.2 wt % to 2.0 wt %, based on a total weight of the fluoropolymer dispersion composition. For example, the fluoropolymer dispersion composition may include the aqueous additive composition in an amount of from 0.1 wt % to 5 wt %, preferably 0.5 to 5 wt %, more preferably 0.75 wt % to 4 wt %, or 1 wt % to 3.5 wt %, based on the total weight of the fluoropolymer dispersion composition.

In one or more embodiments, the fluoropolymer dispersion composition may further include a buffer, wherein the fluoropolymer dispersion composition may have a pH of 2 to 12. For example, the fluoropolymer dispersion composition may further include a buffer, and the fluoropolymer dispersion composition may have a pH of 3 to 10, or 4 to 9. Preferred buffers are aqueous solutions. The aqueous additive may comprise, consist essentially of, or consist of an acidic aqueous buffer solution.

In one or more embodiments, the buffer may include a citrate salt, a phosphate salt, an acetate salt, a bicarbonate salt, boric acid, a borate salt, or a combination of two or more thereof. Suitable buffers include, but are not limited to, sodium phosphate, sodium acetate, sodium citrate, sodium borate, boric acid, or the like, or a combination of two or more thereof. Alternatively, a base, such as sodium hydroxide, ammonium hydroxide, or cesium hydroxide may be used to control pH.

When present in the aqueous additive composition, the buffer may be included in an amount of 0.01 wt % to 20 wt %, or 0.01 wt % to 10 wt %, or 0.01 wt % to 1 wt %, based on the total weight of the aqueous additive composition. The sum of the weight percentages of the PVF polymer(s), the latent solvent(s), the optional non-solvent additive(s), the aqueous additive composition, and the optional buffer(s) in the fluoropolymer dispersion composition is 100 wt %, based on the total weight of the fluoropolymer dispersion composition.

The fluoropolymer dispersion composition has a viscosity that is less than a viscosity of a comparable fluoropolymer dispersion composition that includes the same fluoropolymer and the same latent solvent, wherein the comparable fluoropolymer dispersion composition does not include the aqueous additive composition. The present inventors have surprisingly discovered that the use of specific amounts of the aqueous additive composition in the fluoropolymer dispersion composition can provide an unexpectedly reduced viscosity and reduced thixotropy. Moreover, the observed decrease in viscosity based on the addition of the aqueous additive composition is not a dilution effect.

In one or more embodiments, the fluoropolymer dispersion composition may have a viscosity that is 10% to 70%, preferably 15% to 70%, more preferably 20% to 70% less than the viscosity of the comparable coating composition at 25° C., wherein the comparable fluoropolymer dispersion composition includes the same fluoropolymer and the same latent solvent, but where the comparable fluoropolymer dispersion composition does not include the aqueous additive composition. The viscosity may be measured with a Brookfield Viscometer (e.g., Spindle 00 or #4; 25° C.; at 1, 5, 10, or 100 rpm).

For example, the fluoropolymer dispersion composition may have a viscosity that is 10% to 70%, preferably 15% to 70%, more preferably 20% to 70% less than the viscosity of the comparable coating composition when measured at 1 rpm and 25° C., by Brookfield viscometer using the #4 spindle, wherein the comparable fluoropolymer dispersion composition includes the same fluoropolymer and the same latent solvent, but where the comparable fluoropolymer dispersion composition does not include the aqueous additive composition. For example, the fluoropolymer dispersion composition may have a viscosity that is 10% to 70%, preferably 15% to 70%, more preferably 20% to 70% less than the viscosity of the comparable coating composition when measured at 5 rpm and 25° C., by Brookfield viscometer using the #4 spindle, wherein the comparable fluoropolymer dispersion composition includes the same fluoropolymer and the same latent solvent, but where the comparable fluoropolymer dispersion composition does not include the aqueous additive composition. For example, the fluoropolymer dispersion composition may have a viscosity that is 10% to 70%, preferably 15% to 70%, more preferably 20% to 70% less than the viscosity of the comparable coating composition when measured at 10 rpm and 25° C., by Brookfield viscometer using the #4 spindle, wherein the comparable fluoropolymer dispersion composition includes the same fluoropolymer and the same latent solvent, but where the comparable fluoropolymer dispersion composition does not include the aqueous additive composition. For example, the fluoropolymer dispersion composition may have a viscosity that is 10% to 70%, preferably 15% to 70%, more preferably 20% to 70% less than the viscosity of the comparable coating composition when measured at 100 rpm and 25° C., by Brookfield viscometer using the #4 spindle, wherein the comparable fluoropolymer dispersion composition includes the same fluoropolymer and the same latent solvent, but where the comparable fluoropolymer dispersion composition does not include the aqueous additive composition.

Further provided herein is a fluoropolymer coating composition comprising the fluoropolymer dispersion composition and one or more coating additives, or a coating additive composition that includes one or more coating additives, as described herein. The sum of the weight percentages of the fluoropolymer dispersion composition and the coating additive composition is 100 wt %, based on the total weight of the fluoropolymer coating composition.

The coating additive composition may include a polymer component. The polymer component may include one or more polymers. Examples of suitable resins for use in the fluoropolymer coating compositions include resins such as polycarbonates, polyesters, silicon-functionalized polyesters, polyethers, polysiloxanes, urethanes, amino resins, acrylic resins, alkyd resins, epoxy resins, phenolic resins, cyclized olefin rubbers, halogenated polyolefins, halo-sulfonated polyolefins, polybutadiene rubbers, natural resins, copolymers of two or more thereof, and combinations of two or more thereof. Particularly useful are acrylic resins and polyesters.

In some aspects, the polymer component may include functional groups selected from amine, carboxylic acid, sulfonic acid, aziridine, amine, melamine, epoxy, isocyanate, hydroxy, anhydride, or a combination of two or more thereof. Particularly useful polymers include acrylic, urethane, aliphatic polyester, polyester urethane, polyether, ethylene vinyl alcohol copolymer, amide, acrylamide, urea, and polycarbonate backbones having such functional groups.

The free radical addition polymers derived from acrylic and acrylamide monomers are well suited to the introduction of pendant functional groups using functional monomers available in the art. Some representative examples include glycidyl acrylate and methacrylate for the introduction of epoxy groups. Carboxylic acid, isocyanate, hydroxy and anhydride functionalities are all available using acrylic/methacrylic acid, isocyanatoethyl methacrylate, hydroxyethyl methacrylate, or maleic anhydride, respectively. Numerous other functional monomers are available for functional group introduction as is well known in the art.

When a polymer component is included in the coating additive composition, it may be included in an amount from 0.1 wt % to 50 wt %, or from 1 wt % to 35 wt %, or from 5 wt % to 30 wt %, based on the total weight of the solids, that is, the non-solvent and non-aqueous components of the fluoropolymer dispersion composition.

The term “acrylic resin,” as used herein, refers to polymers, copolymers, and terpolymers formed from alkyl methacrylate or alkyl acrylate monomers, polymers including copolymerized mixtures of two or more of these monomers, and combinations of two or more acrylic resins. The alkyl methacrylate monomer is preferably methyl methacrylate, which may make up from 50 to 100 molar percent of the monomer mixture. Optionally up to 50 percent of other acrylate and methacrylate monomers or other ethylenically unsaturated monomers, included but not limited to, styrene, alpha methyl styrene, acrylonitrile, and crosslinkers may also be present in the monomer mixture. Other examples of suitable methacrylate and acrylate monomers for use in the monomer mixture include, but are not limited to, methyl acrylate, ethyl acrylate and ethyl methacrylate, butyl acrylate and butyl methacrylate, iso-octyl methacrylate and acrylate, lauryl acrylate, and lauryl methacrylate, stearyl acrylate and stearyl methacrylate, isobornyl acrylate and methacrylate, methoxy ethyl acrylate and methacrylate, 2-ethoxy ethyl acrylate and methacrylate, hydroxymethyl acrylate and methacrylate, hydroxyethyl acrylate and methacrylate, dimethylamino ethyl acrylate and methacrylate monomers.

The acrylic resins may be obtained by polymerizing a suitable combination of a functional group-containing monomer and another copolymerizable monomer according to methods that are known in the art. For example, the polymerization temperature may be 60° C. to 100° C., and polymerization time is usually within a range of 3 hours to 10 hours. Examples of the functional group-containing monomers include hydroxyl group-containing monomers such as beta-hydroxyethyethyl acrylate, beta-hydroxypropyl acrylate, beta-hydroxyethyl methacrylate, beta-hydroxypropyl methacrylate, N-methylol acrylamide, and N-methylol methacrylamide; carboxyl group-containing monomers such as acrylic acid, methacrylic acid, itaconic acid, maleic acid, fumaric acid, as well as monoesters of maleic acid and fumaric acid with monoalcohols; alkoxyl group-containing monomers such as N-butoxy-methylmethacrylamide and N-butoxymethylacrylamide; and epoxy group-containing monomers such as glycidyl methacrylate, glycidyl acrylate, and allyl glycidyl ether. These monomers may be used either alone or in a combination of two or more. The functional group-containing monomer is used in an amount of about 5 to about 40% by weight of total monomers. Examples of the monomers copolymerized with these functional group-containing monomers include olefinically unsaturated monomers such as ethylene propylene and isobutylene; aromatic monomers such as styrene, vinyltoluene and alphamethylstyrene; ester of methacrylic acid and alcohols of 1 to about 18 carbon atoms such as methylmethacrylate, ethylmethacrylate, propylmethacrylate, n-butylmethacrylate, isobutylmethacrylate, cyclohexylmethacrylate, 2-ethylhexylmethacrylate, and laurylmethacrylate; vinyl esters of carboxylic acid of about 1 to about 11 carbon atoms such as vinyl acetate, vinyl propionate, and vinyl 2-ethylhexylic acid; as well as vinyl chloride, acrylonitrile, methacrylonitrile, or the like.

Commercially available examples of suitable polymer components include without limitation hydroxy-functional acrylic resins such as JONCRYL® (BASF Resins), MACRYNAL® (Cytec Industries), PARALOID® (Dow Coating Materials), G-CURE®, TSAX®, and/or SETALUX® (Nuplex Resins, LLC) in solution or emulsion form.

The polymer component may include a blocked isocyanate or urethane crosslinking agent. Typical blocking agents that can be used to form blocked polyisocyanate crosslinking agents include, for example, phenol compounds, alcohols, such as tertiary butyl alcohols, ketoximes, glycol esters, or the like. Typical phenol compounds that may be used include phenol, propyl phenols, tertiary butyl phenol, nonyl phenol, other monohydric phenols, bromophenol, 2-chlorophenol, dichlorophenol, lithoxyphenol, Z-methoxy nitrophenol, or the like. Exemplary ketoximes include, for example, acetoxime, methyl ethyl ketoxime, diisobutyl ketoximes, or the like. When the polymer component is cross-linkable, it is also referred to herein as a “cross-linking agent.”

The coating additive composition may further include a cross-linking agent that is a small, multifunctional molecule designed to react with one or more polymer molecules that comprise a co-polymerized reactive group, such as those described above. Examples of suitable cross-linking agents in this category include, without limitation, sulfur, multifunctional bases, multifunctional vinyl-containing molecules, ethylene glycol di(meth)acrylate, methylene bisacrylamide, N-(1-hydroxy-2,2-dimethoxyethyl) acrylamide, and divinyl benzene. One of skill in the art can determine an appropriate amount of cross-linking agent in the coating additive composition based on the stoichiometry of the polymer to be cross-linked and the desired degree of cross-linking.

The coating additive composition may also include one or more pigments or one or more fillers. The pigment may be organic or inorganic. If desired, various color, opacity, and/or other property effects can be achieved by incorporating pigments or fillers into the fluoropolymer dispersion composition during manufacture. Pigments and fillers preferably are used in amounts of 0.1 wt % to 50 wt %, or 0.1 wt % to 40 wt %, or 0.1 wt % to 35 wt %, based on the total weight of the coating additive composition.

Typical pigments that may be used include both clear pigments, such as inorganic siliceous pigments (silica pigments, for example), and conventional pigments. Conventional pigments that may be used include metallic oxides such as titanium dioxide, and iron oxides; metal hydroxides; metal flakes, such as aluminum flake; chromates, such as lead chromate; sulfides; sulfates; carbonates; carbon black; silica; talc; china clay; phthalocyanine blues and greens; organo reds; organo maroons and other organic pigments and dyes. Preferred are pigments that are stable at high temperatures, for example during processing, such as coating film formation and curing steps. It is also preferable that the type and amount of pigment is selected to prevent any significant adverse effects on the desirable properties of fluoropolymer coating, e.g., weatherability.

The preferred pigments include, for example, those pigments identified in U.S. Pat. No. 3,340,222. According to some embodiments, the pigment may include titanium dioxide, or titanium dioxide in combination with one or more other inorganic pigments wherein titanium dioxide is a major part of the combination. Inorganic pigments which may be used alone or in combination with titanium dioxide include, for example, silica, iron oxides of various colors, cadmiums, lead titanate, and various silicates, for example, talc, diatomaceous earth, asbestos, mica, clay, and basic lead silicate. Pigments which may be used in combination with titanium dioxide include, for example, zinc oxide, zinc sulfide, zirconium oxide, white lead, carbon black, lead chromate, leafing and non-leafing metallic pigments, molybdate orange, calcium carbonate, and barium sulfate.

In some embodiments, useful organic pigments include but are not limited to: Aniline black (Pigment Black 1), Anthraquinone black, Monoazo type, Diazo type, Benzimidazolones, Diarylide yellow, Monoazo yellow salts, Dinitaniline orange, Pyrazolone orange, Azo red, Naphthol red, Azo condensation pigments, Lake pigments, Copper Phthalocyanine blue, Copper Phthalocyanine green, Quinacridones, Diaryl Pyrrolopyrroles, Aminoanthraquinone pigments, Dioxazines, Isoindolinones, Isoindolines, Quinophthalones, phthalocyanine pigments, idanthrone pigments, pigment violet 1, pigment violet 3, pigment violet 19, or pigment violet 23. In yet another embodiment, the organic pigment is a Vat dye pigment, such as but not limited to: perylene, perylene black, perinones, or thioindigo. In one or more embodiments, the organic pigment may include a phthalate.

In one or more embodiments, the inorganic pigment may include titanium dioxide, zinc oxide, silica, alumina, barium sulfate, talc, mica, kaolin, or a combination thereof.

Also suitable for use in the coating additive compositions are corrosion-inhibitive pigment types, such as chromates, silicas, silicates, phosphates, and molybdates, as well as those described in U.S. Patent Application Publication No. 2008-0022886A1 at [0020] to and to [0109]. Extender or filler pigments suitable for use in the present invention include kaolin, talc, calcium carbonate, diatomaceous earth, synthetic calcium silicates, perlite, cellulose fibers, ground silica, calcined clays, microspheres, fumed silica, treated fumed silicas, titanium dioxide, wet ground micas, synthetic fibers, snobrite clay, bentonite clay, micronized micas, attapulgite clays, and alumina trihydrate.

Pigments and fillers may be formulated into a millbase by standard methods, for example by mixing them with a suspending medium, such as water or a solvent, and with a dispersant or dispersing resin that may be the same as or compatible with the fluoropolymer of the fluoropolymer dispersion composition into which the pigment is to be incorporated. As used in this context, the term “compatible” means that the dispersant does not prevent fluoropolymer film formation, and that it does not detract from the physical properties of the film by interfering with adhesion between the fluoropolymer and the coated surface or between the fluoropolymer and the pigments or fillers. Pigment dispersions can be formed by conventional means, such as sand grinding, ball milling, attritor grinding, two-roll milling, or the like. Other additives, while not generally needed or used, such as one or more of fiber glass and mineral fillers, anti-slip agents, plasticizers, nucleating agents, or the like, may be incorporated into the pigment grind and, therefore, in the coating additives composition. Preferably, the total amount of the other additive(s) is less than 5.0 wt %, less than 3.0 wt %, less than 2.0 wt %, less than 1.0 wt %, or less than 0.50 wt %, based on the total weight of the coating additives composition.

In one or more embodiments, the coating additive composition may further include a thermal stabilizer. Exemplary thermal stabilizers may include inorganic and organometallic compounds, such as lead, barium-cadmium, and cadmium-zinc. Nitrogenous and epoxy compounds are well known stabilizers. Such stabilizers include a barium-zinc soap stabilizer, epoxidized soybean oil, and inorganic salts. Examples of the thermal stabilizers also include metal soaps such as magnesium stearate, aluminum stearate, calcium stearate, barium stearate, zinc stearate, calcium laurate, barium laurate, zinc laurate, or the like; organotin compounds such as dibutyltin dilaurate, dibutyltin dimaleate, monobutyltin mercaptide, or the like; phosphorous acid esters such as diethyl phosphite, dibutyl phosphite, dioctyl phosphite, diphenyl isodecyl phosphite, tricresyl phosphite, triphenyl phosphite, tris(nonylphenyl) phosphite, triisooctyl phosphite, or the like. Other thermal stabilizers are described in U.S. pat. No. 5,44,7975.

Other exemplary thermal stabilizers thermal stabilizers may include sterically hindered phenols, in particular those containing at least one 2,6-di-tert-butylphenyl and/or 2-tert-butyl-6-methylphenyl group, and also hypophosphites such as sodium hypophosphite NaH2PO2, hydroquinones, aromatic secondary amines, substituted resorcinols, salicylates, benzotriazoles, and benzophenones, 3,3′-thiodipropionic esters, and variously substituted representatives of these groups or mixtures thereof. Still other exemplary thermal stabilizers may include copper salts, such as copper (I) iodide, (triphenylphosphino) copper iodide, or a combination thereof. Thermal stabilizers may be present in the coating additive composition in an amount of from 0.1 wt % to 5 wt %, preferably 0.3 wt % to 3 wt %, more preferably 0.5 wt % to 2 wt % based on the total weight of the solids of the coating additive composition.

In one or more embodiments, the coating additive composition may further include a light stabilizer. Light stabilizer additives include compounds that absorb ultraviolet radiation such as hydroxybenzophenones, hydroxyphenyl-triazines, hydroxybenzotriazoles, or the like. Other possible light stabilizer additives include hindered amine light stabilizers (HALS) and antioxidants. Hindered amine light stabilizers may include bis(1,2,2,6,6-pentamethyl-4-piperidyl) sebacate, methyl 1,2,2,6,6-pentamethyl-4-piperidyl sebacate, bis(2,2,6,6-tetramethyl-4-piperidyl) sebacate (e.g., Tinuvin® 770, BASF Corporation), poly(4-hydroxy-2,2,6,6-tetramethyl-1-piperidine ethanol-alt-1,4-butanedioic acid) (e.g., Tinuvin® 622, BASF Corporation), or the like, or a combination thereof. For example, the hydroxyphenyl-triazine can include 2-hydroxyphenyl-s-triazine (such as Tinuvin® 479 or Tinuvin® 460, BASF Corporation). Light stabilizers may be present in the coating additive composition in an amount of from 0.1 wt % to 5 wt %, preferably 0.3 wt % to 3 wt %, more preferably 0.5 wt % to 2 wt % based on the total weight of the solids of the coating additive composition.

In one or more embodiments, the coating additive composition may further include an anti-ultraviolet agent or antioxidant, such as tetrakis(methylene (3,5-di(tert)butyl-4-hydroxyhydrocinnamate)) methane under the trade names Irganox® 1010 and Irganox® 1076 (BASF Corporation). Other suitable antioxidants include phosphorous acid salts or esters, e.g., ULTRANOX 626 and Westin® 619 sold by GE Specialty Chemical. Irgafos® 168 (tris(2,4-di-tert-butylphenyl)phosphite) sold by BASF is a common heat stabilizer and is commonly used as an auxiliary antioxidant. Anti-ultraviolet agent or antioxidant may be present in the coating additive composition in an amount of from 0.1 wt % to 5 wt %, preferably 0.3 wt % to 3 wt %, more preferably 0.5 wt % to 2 wt % based on the total weight of the solids of the coating additive composition.

In one or more embodiments, the coating additive composition may further include a flow agent. Exemplary flow agents may include polysiloxane-polyalkylene oxide graft copolymers, such as Efka®3288 (BASF Corporation). Flow agent may be present in the coating additive composition in an amount of from 0.1 wt % to 5 wt %, preferably 0.3 wt % to 3 wt %, more preferably 0.5 wt % to 2 wt % based on the total weight of the solids of the coating additive composition.

In one or more embodiments, the coating additive composition may further include a leveling agent. Exemplary leveling agents may include Efka® FL 3670 (BASF Corporation). Leveling agent may be present in the coating additive composition in an amount of from 0.1 wt % to 5 wt %, preferably 0.3 wt % to 3 wt %, more preferably 0.5 wt % to 2 wt % based on the total weight of the solids of the coating additive composition.

In one or more embodiments, the coating additive composition may further include a surfactant or an anti-settling agent. Useful anti-settling agents include, but are not limited to, ionic substances, such as salts of alkyl sulfates, sulfonates, phosphates, phosphonates (such as sodium lauryl sulfate, ammonium lauryl sulfate, or the like), and salts of partially fluorinated alkyl sulfates, carboxylates, phosphates, phosphonates (such as the CAPSTONE from DuPont), and non-ionic surfactants such as the TRITON X series (from Dow) and PLURONIC series (from BASF). The LEOCOL family of surfactants from Lion Corporation are also useful as anti-settling agents. Anti-settling agent may be present in the coating additive composition in an amount of from 0.1 wt % to 5 wt %, preferably 0.3 wt % to 3 wt %, more preferably 0.5 wt % to 2 wt % based on the total weight of the solids of the coating additive composition. The sum of the weight percentages of the components of the coating additives composition is 100 wt %, based on the total weight of the coating additives composition. The sum of the weights of the fluoropolymer dispersion composition and the coating additives composition in the fluoropolymer coating composition is 100 wt %, based on the total weight of the fluoropolymer coating composition.

To prepare the fluoropolymer dispersion composition in dispersion form, the fluoropolymer may be milled in a suitable solvent. To prepare the fluoropolymer coating composition, the fluoropolymer dispersion may be combined with a separately prepared coating additive composition. For example, a pigment dispersion along with a dispersing agent may be milled before mixing with the fluoropolymer and any other components that may be used in the fluoropolymer dispersion composition. The fluoropolymer dispersion composition and the coating additive composition are combined in amounts such that the fluoropolymer may be present in the fluoropolymer coating composition in an amount of from 50 wt % to 95 wt %, preferably 75 wt % to 95 wt %, more preferably 80 wt % to 95 wt %; the other non-fluoropolymer resin may be present in the fluoropolymer coating composition in an amount of from 1 wt % to 50 wt %, preferably 3 wt % to 30 wt %, more preferably 5 wt % to 20 wt %; the pigments may be present in the fluoropolymer coating composition in an amount of from 1 wt % to 50 wt %, preferably 3 wt % to 30 wt %, more preferably 5 wt % to 20 wt %; the thermal stabilizers may be present in the fluoropolymer coating composition in an amount of from 0.1 wt % to 5 wt %, preferably 0.3 wt % to 3 wt %, more preferably 0.5 wt % to 2 wt %; and the UV stabilizers may be present in the fluoropolymer coating composition in an amount of from 0.1 wt % to 5 wt %, preferably 0.3 wt % to 3 wt %, more preferably 0.5 wt % to 2 wt %, wherein the weight percentages are based on the total weight of the solids of the fluoropolymer coating composition. Components which are soluble in the solvent do not require milling. Alternatively, the fluoropolymer coating composition can be prepared in dispersion form by high shear dispersing. Preferably, the method set forth in the example preparation step could be followed: the PVF and pigment dispersions are combined and mixed for 5 minutes using high shear disperser (HSD) at 3000 rpm. Other non-fluoropolymer resin solution is added and mixed for 5 minutes using high shear disperser (HSD) at 3000 rpm. Finally, stabilizer additives are added to the mixture and mixed for 15 min using high shear disperser (HSD) at 3000 rpm.

A wide variety of mills can be used for the preparation of both pigment and fluoropolymer dispersions. Typically, the mill employs a dense agitated grinding medium, such as sand, steel shot, glass beads, ceramic shot, zirconia, or pebbles, as in a ball mill, an ATTRITOR® available from Union Process, Akron, Ohio, or an agitated media mill such as a “Netzsch” mill available from Netzsch, Inc., Exton, Pa. The fluoropolymer dispersion may be milled for a time sufficient to cause de-agglomeration of the fluoropolymer particles to achieve 92 wt % particle that having size less than 2 micrometer (measured by Horiba Laser Scattering Particle Size Distribution Analyzer). Typical residence time of the dispersion in a Netzsch mill ranges from thirty seconds up to ten minutes. Milling conditions of the fluoropolymer dispersion (e.g., temperature) are controlled to avoid swelling or gelation of the fluoropolymer particles.

The fluoropolymer dispersion composition may contain the fluoropolymer in the form of a dispersion of the fluoropolymer. Typical dispersions for the fluoropolymer are prepared using solvents that have boiling points that are high enough to avoid bubble formation during the film forming/drying process. For polymers in dispersion form, a solvent which aids in coalescence of the fluoropolymer is desirable. The polymer concentration in these dispersions is adjusted to achieve a workable viscosity and will vary with the particular polymer, the other components of the fluoropolymer dispersion composition, and the process equipment and conditions used. Preferably, the polymer concentration in these dispersions is in an amount of from 30 wt % to 60 wt %, preferably 40 wt % to 55 wt %, more preferably 45 wt % to 50 wt %, based on the total weight of the fluoropolymer dispersion composition.

Also provided is a coated substrate that includes a layer of the fluoropolymer dispersion or the fluoropolymer coating composition disposed on at least a portion of at least one surface of a substrate. Suitable metallic substrates include, but are not limited to, foils, sheets, or workpieces constructed of cold rolled steel, stainless steel and steel surface-treated with any of zinc metal, zinc compounds, and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel, and aluminum alloy plated steel substrates may also be used. Steel substrates (such as cold rolled steel or any of the steel substrates listed above) coated with a weldable, zinc-rich or iron phosphide-rich organic coating are also suitable for use. Such weldable fluoropolymer dispersion compositions are disclosed in, for example, U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, another conversion coating, or a combination of two or more of these solutions. Also, suitable metallic substrates include silver, gold, and alloys thereof, which may be pre-treated or not.

Examples of suitable polymeric substrates include, without limitation, polar polymers such as polyesters, polyamides, and the like. Examples of suitable textile substrates include fibers, yarns, threads, knits, wovens, nonwovens and garments composed of polyester, modified polyester, polyester blend fabrics.

The fluoropolymer dispersion or coating compositions may be applied to the substrates by any of a variety of methods including spraying, brushing, dipping, and roll coating, among other methods. In certain embodiments, however, the fluoropolymer dispersion and coating compositions described herein are particularly suited to be applied to a metal coil by roll coating. As a result, embodiments are also directed to a method of coil coating a metal substrate, to the coil coated substrate, and to the cured coil-coated substrate. In the present coil coating method, a coil coating apparatus is used to apply the fluoropolymer dispersion or coating composition. The fluoropolymer dispersion and coating compositions are often applied such that the wet film thickness is 1 to 10 mils. The coating is then heated at, for example, a temperature of from 160° C. to 300° C., or from 190° C. to 300° C. for 10 seconds to 50 seconds to form a cohesive dry film with a film thickness of, for example, 0.5 to 6 mils, but embodiments are not limited thereto. When the fluoropolymer coating composition comprises a crosslinking agent, the cohesive dry film is also cured during this heating step.

Also provided is a method of spray coating a substrate and the spray coated substrate. In the present spray coating method, a spray coating apparatus is used to apply the fluoropolymer dispersion or coating composition. The fluoropolymer dispersion or coating composition is often applied such that the wet film thickness is 1 to 4 mils. The coating is dried at, for example, a temperature of 200° C. to 300° C. for 5 to 20 minutes to form a cohesive dry film with a film thickness of, for example, 0.3 to 2 mils, but embodiments are not limited thereto. When the fluoropolymer coating composition comprises a crosslinking agent, the cohesive dry film is also cured during this heating step.

Also provided are multi-layer composite coatings, which may include a base-coat film-forming composition serving as a basecoat (often a pigmented color coat) and a film-forming composition applied over the basecoat serving as a topcoat (often a transparent or clear coat). At least one of the basecoat film-forming composition and the topcoat film-forming composition is deposited from the fluoropolymer dispersion or coating compositions as described herein. In certain embodiments, the basecoat may be deposited from the fluoropolymer dispersion or coating composition as described herein and, in certain embodiments, the topcoat, such as a transparent or clear coat, may be deposited from a fluoropolymer dispersion composition or from a fluoropolymer coating composition, which may be the same as or different from a fluoropolymer dispersion composition or a fluoropolymer coating composition as described herein, that comprises a fluorocarbon polymer.

Another aspect provides a cured film that may be derived from the fluoropolymer dispersion or coating composition as described herein that comprises a cross-linking agent, or from the coated substrate as described herein produced from a fluoropolymer coating composition that comprises a cross-linking agent. The cured film may be prepared by casting the fluoropolymer dispersion or coating composition on a polymer film, heating the cast fluoropolymer dispersion or coating composition to form a cohesive film, and removing the cohesive film from the polymer film to provide the cured film. In one or more embodiments, the cured film may be a free-standing film.

For example, the fluoropolymer dispersion or coating composition may be made into a film by casting the fluoropolymer dispersion or coating composition into the shape of a film by techniques known to those in the art, such as conventional die casting techniques, or by coating onto a polymer web by gravure, reverse gravure, or roll-coating. The film may be formed as a single layer or multilayer construction. The film may be formed on a carrier film such as polyester (PET). Also, the film may be formed as a “free-standing” film whereby the fluoropolymer dispersion or coating composition is coated into a flat surface from which it is released. The film may be formed in various embodiments, including both roll and sheet forms.

As a means of forming a multilayer construction, various methods known to those in the art may be utilized including extrusion-lamination, thermal compression, and solution coating. These are typical, but not exclusive examples of the methods available for forming a multilayer film.

The following examples are provided to describe the invention in further detail. These examples, which set forth specific embodiments and a preferred mode presently contemplated for carrying out the invention, are intended to illustrate and not to limit the invention.

### EXAMPLES

The reagents are from commercial sources and are used without further purification unless noted otherwise.

The procedures below describe the preparation of the TiO₂ dispersion, which is then combined with PVF dispersion 44-1010 and other commercially available components to provide topcoat formulations. PVF dispersion “44-1010” is commercially available from DuPont de Nemours, Inc., of Wilmington, DE.

### Preparation of TiO₂ Dispersion

8920 grams (g) of butoxyethyl acetate (BEA) solvent were combined with 400 g of Efka PX 4330 dispersing agent (TiO₂ pigment dispersant/stabilizer from BASF of Ludwigshafen, Germany) in round bottom flask, and the contents were stirred for 10 minutes. To this mixture, 14 kilograms (kg) of TiO₂ (R-960 from The Chemours Company, of Wilmington, DE) was added while stirring at 750 revolutions per minute (rpm) for 10 minutes. The resulting mixture was mixed using a high shear disperser (HSD) at 2000 rpm for 30 minutes and an ice water bath was used to regulate the temperature during the mixing. The resulting mixture was then passed through a sand mill for one minute to provide the TiO₂ dispersion that was used in the next step.

### Preparation of Topcoat Formulation

7.2 kg of PVF dispersion 44-1010 was combined with 30 g of Syloid 308 (matting/gloss control agent from W. R. Grace and Company of Columbia, MD), and then mixed using a HSD at 2000 rpm for 15 minutes. While mixing, 2.4 kg of the TiO₂ dispersion was then added to the mixture, and the resulting mixture was mixed for an additional 5 minutes. Then, 84 g of Irganox 1035 (antioxidant/heat stabilizer from BASF) and 120.4 gram of propylene carbonate were added into the mixture, and the resulting combination was mixed for 5 minutes. 200 g of 30% PARALOID™ B-44 thermoplastic acrylic resin in propylene carbonate was then added to the above mixture, and this combination was then mixed for 15 minutes further. The product was then filtered through a 50-micron membrane filter to provide the topcoat formulation.

### Example 1

Example 1 demonstrates the unexpected ability to adjust the viscosity of the topcoat formulations by adding water.

These samples were prepared by combining 130 g of the topcoat formulation and a specified amount of water, as provided in Table 1 where the amounts are in weight percent based on the total weight of the topcoat formulations. The viscosity of the mixture was measured using Brookfield viscometer at various spindle speeds of #4 spindle (1, 5, 10, 100 rpm, as specified in Table 1). The thixotropy was calculated as the ratio of the viscosity at 1 rpm to the viscosity at 100 rpm. The viscosity is reported as centipoise (cPs).

TABLE 1

| | | | | | Thixotropy |
|---|---|---|---|---|---|
| | 1 rpm | 5 rpm | 10 rpm | 100 rpm | (1/100 rpm) |
| 0 wt % water | 13600 | 3800 | 2240 | 490 | 27.76 |
| 0.25 wt % water | 10600 | 3040 | 1840 | 418 | 25.36 |
| 0.5 wt % water | 9000 | 2520 | 1560 | 360 | 25.00 |
| 0.75 wt % water | 7200 | 2120 | 1300 | 316 | 22.78 |
| 1 wt % water | 6000 | 1880 | 1140 | 284 | 21.13 |
| 1.25 wt % water | 5200 | 1520 | 980 | 260 | 20.00 |
| 1.5 wt % water | 4000 | 1280 | 860 | 242 | 16.53 |
| 2 wt % water | 7200 | 2400 | 1640 | 460 | 15.65 |
| 5 wt % water | 6400 | 2160 | 1480 | 420 | 15.24 |
| 10 wt % water | 8000 | 2880 | 1720 | 528 | 15.15 |
| 20 wt % water | 24400 | 7760 | 1968 | 1388 | 17.58 |

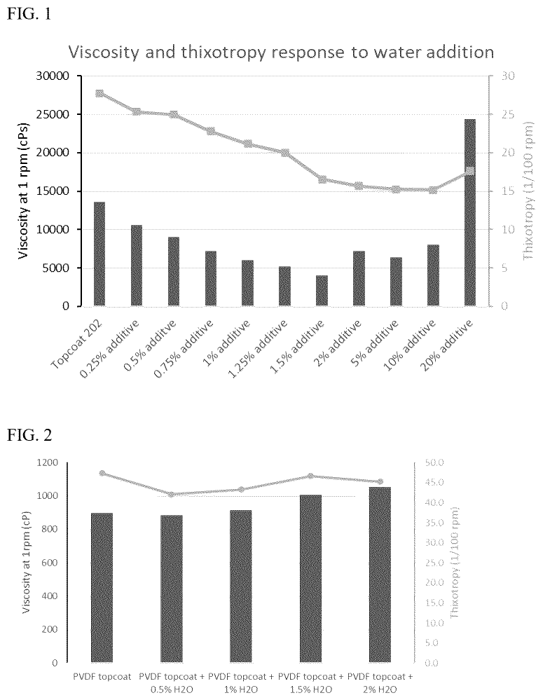

As shown in Table 1 and depicted in FIG. 1, the viscosity of the topcoat formulations decreased with water increasing from 0 wt % to 1.5 wt %. The viscosity was found to increase when greater than 1.5 wt % of water added, however, which was unexpected. In addition, the thixotropy was found to decrease with added water, even upon addition of more than 1.5 wt % of water. The decreases in viscosity and thixotropy were not attributable to a simple dilution effect because neither the viscosity nor the thixotropy continuously decreased with increasing water content.

### Comparative Example 1

Comparative Example 1 demonstrates that the unexpected ability to adjust the viscosity of the topcoat formulations by adding water was only achieved for poly(vinyl fluoride), whereas the same unexpected result was not observed when using poly(vinylidene fluoride).

These samples were prepared by combining 130 g of a comparative topcoat formulation that was prepared as described above, but using PVDF instead of PVF, and a specified amount of water, as provided in Table 2 where the amounts are in weight percent based on the total weight of the comparative topcoat formulations. The viscosity of the comparative mixture was measured using Brookfield viscometer at various spindle speeds of #4 spindle (1, 5, 10, 50, 100 rpm, as specified in Table 2). The thixotropy was calculated as the ratio of the viscosity at 1 rpm to the viscosity at 100 rpm. The viscosity is reported as centipoise (cPs).

TABLE 2

| | 1 | 5 | 10 | 50 | 100 | Thixotropy |
|---|---|---|---|---|---|---|
| | rpm | rpm | rpm | rpm | rpm | (1/100 rpm) |
| PVDF topcoat | 42400 | 9200 | 5320 | 1424 | 896 | 47.3 |
| PVDF topcoat + | 37200 | 9120 | 4960 | 1408 | 884 | 42.1 |
| 0.5% H₂O | | | | | | |
| PVDF topcoat + | 39600 | 9680 | 5560 | 1488 | 916 | 43.2 |
| 1% H₂O | | | | | | |
| PVDF topcoat + | 46800 | 10720 | 6120 | 1656 | 1004 | 46.6 |
| 1.5% H₂O | | | | | | |
| PVDF topcoat + | 47600 | 11600 | 6520 | 1800 | 1052 | 45.2 |
| 2% H₂O | | | | | | |

As shown in Table 2 and depicted in FIG. 2, adding water to the PVDF topcoat did not reduce the viscosity as was observed for the PVF topcoat in Example 1. The addition of water to the PVDF topcoat also did not substantially decrease the thixotropy. Instead, the results in Table 2 show that adding water above 1.5 wt % in the PVDF topcoat even increased the viscosity with only a moderate decrease to thixotropy.

### Comparative Example 2

Comparative Example 2 demonstrates that the unexpected ability to adjust the viscosity of the topcoat formulations by adding water was only achieved when the aqueous additive composition included water, whereas the same unexpected result was not observed when using only propylene carbonate instead of water as the aqueous additive composition.

These samples were prepared by combining 130 g of a topcoat formulation that was prepared as described above and a specified amount of propylene carbonate (PC) instead of water, as provided in Table 3, where the amounts are in weight percent based on the total weight of the comparative topcoat formulations. The viscosity of the comparative mixture was measured using Brookfield viscometer at various spindle speeds of spindle #4 (0.3, 1, 5, 10, 50, 100 rpm, as specified in Table 3). The thixotropy was calculated as the ratio of the viscosity at 1 rpm to the viscosity at 100 rpm. The viscosity is reported as centipoise (cPs).

TABLE 3

| | | | | | | | | Thixotropy |
|---|---|---|---|---|---|---|---|---|
| | 0.3 rpm | 0.6 rpm | 1 rpm | 5 rpm | 10 rpm | 50 rpm | 100 rpm | (1/100 rpm) |
| 0 wt % loading | 92000 | 50667 | 33200 | 8960 | 5280 | 1760 | 1152 | 28.8 |
| 0.25 wt % PC | 92000 | 50667 | 32400 | 8800 | 5240 | 1736 | 1136 | 28.5 |
| 0.5 wt % PC | 90667 | 50667 | 32800 | 8800 | 5240 | 1736 | 1116 | 29.4 |
| 0.75 wt % PC | 84000 | 48667 | 32400 | 8640 | 5080 | 1680 | 1100 | 29.5 |
| 1 wt % PC | 86667 | 48000 | 31200 | 8480 | 4960 | 1656 | 1068 | 29.2 |

As shown in Table 3, adding propylene carbonate instead of water to the topcoat formulations did not result in a similar reduction in viscosity or thixotropy as observed in Table 1. In addition, the results in Table 3 showed that a much smaller viscosity decrease was achieved than by adding the same weight percentage of water. As a result, the viscosity decrease caused by water addition in Table 1 was not a dilution effect.

### Example 2

Example 2 demonstrates that the unexpected ability to adjust the viscosity of the topcoat formulations by adding water was achieved over the pH range of from 2 to 12.

These samples were prepared by combining 130 g of a topcoat formulation that was prepared as described above and 1.5 wt % of water, where the amounts are in weight percent based on the total weight of the topcoat formulations. The pH was set for each formulation as noted in Table 4, where the pH of the water was adjusted before adding to the topcoat formulation. The water with pH 14 was prepared by dissolving 10 g of NaOH into 90 g of water. Water with a pH of 13 and 12 was prepared by diluting the pH 14 solution by 10 and 100 times, respectively. Water with a pH of 6 was prepared by exposing the water to the ambient atmosphere, where the CO₂ in the air dissolved into the water to provide the slightly acidic pH. Water with a pH of 2 was prepared by dissolving 5.8 g of acetic acid into 94.2 g of water. Water with a pH of 3 and 5 was prepared by dilution the pH 2 water by 10 and 100 times, respectively.

The viscosity of the mixture was measured using Brookfield viscometer at various spindle speeds of spindle #4 (1, 5, 10, 100 rpm, as specified in Table 4). The thixotropy was calculated as the ratio of the viscosity at 1 rpm to the viscosity at 100 rpm. The viscosity is reported as centipoise (cPs).

TABLE 4

| | 1 | 5 | 10 | 100 | Thixotropy |
|---|---|---|---|---|---|
| | rpm | rpm | rpm | rpm | (1/100 rpm) |
| Topcoat formulation + | 13600 | 3800 | 2240 | 490 | 27.76 |
| 0 wt % water | | | | | |
| Topcoat formulation + | 6800 | 2480 | 1640 | 516 | 13.18 |
| additive pH~2 | | | | | |
| Topcoat formulation + | 7600 | 2560 | 1720 | 520 | 14.62 |
| additive pH~3 | | | | | |
| Topcoat formulation + | 8400 | 2960 | 1920 | 544 | 15.44 |
| additive pH~5 | | | | | |
| Topcoat formulation + | 4000 | 1280 | 860 | 242 | 16.53 |
| additive pH~6 | | | | | |
| Topcoat formulation + | 6400 | 2320 | 1520 | 448 | 14.29 |
| additive pH~12 | | | | | |
| Topcoat formulation + | 20000 | 5040 | 2960 | 624 | 32.05 |
| additive pH~13 | | | | | |
| Topcoat formulation + | 150000 | 30720 | 16000 | 2188 | 68.56 |
| additive pH~14 | | | | | |

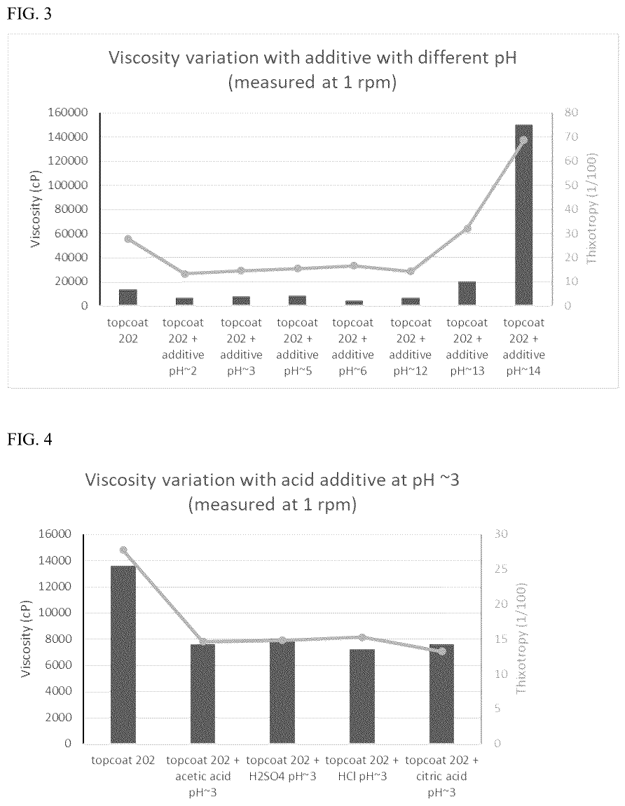

As shown in Table 4 and depicted in FIG. 3, when water was added having a pH in the range of 2 to 12, the viscosity of topcoat formulation was found to decrease. When the water had a pH that was greater than 12, the viscosity of the topcoat formulation was found to increase. In addition, when water was adding having a pH in the range of 2 to 12, the thixotropy was decreased, whereas at pH of 13-14 the thixotropy was found to increase.

### Example 3

Example 3 demonstrates the unexpected ability to adjust the viscosity of the topcoat formulations by adding an aqueous additive composition that included water and an acid.

These samples were prepared by combining 130 g of a topcoat formulation that was prepared as described above and 1.5 wt % of water, where the amounts are in weight percent based on the total weight of the topcoat formulations. The pH was set for each formulation as noted in Table 5, where the pH of the water was adjusted to 3 before adding to the topcoat formulation using the noted acid. The viscosity of the mixture was measured using Brookfield viscometer at various spindle speeds of #4 spindle (1, 5, 10, 100 rpm, as specified in Table 4). The thixotropy was calculated as the ratio of the viscosity at 1 rpm to the viscosity at 100 rpm. The viscosity is reported as centipoise (cPs).

TABLE 5

| | | | | | Thixotropy |
|---|---|---|---|---|---|
| | 1 rpm | 5 rpm | 10 rpm | 100 rpm | (1/100 rpm) |
| Topcoat formulation | 13600 | 3800 | 2240 | 490 | 27.76 |
| Topcoat formulation + | 7600 | 2560 | 1720 | 520 | 14.62 |
| acetic acid, pH~3 | | | | | |
| Topcoat formulation + | 8000 | 2720 | 1840 | 540 | 14.81 |
| H₂SO₄, pH~3 | | | | | |
| Topcoat formulation + | 7200 | 2480 | 1640 | 472 | 15.25 |
| HCl, pH~3 | | | | | |
| Topcoat formulation + | 7600 | 2800 | 1930 | 576 | 13.19 |
| citric acid, pH~3 | | | | | |

As shown in Table 5 and depicted in FIG. 4, when 1.5 wt % of aqueous solutions of different acids, each having a pH of 3, were added to the topcoat formulation, the viscosity was decreased to a similar level regardless of the identity of the acid. Similarly, when 1.5 wt % of these acid solutions were added to the topcoat formulation, the thixotropy was also decreased regardless of the identity of the acid. These results suggest that the proton concentration plays a larger role than the anions in the viscosity and thixotropy of the topcoat formulations, although the inventors are not bound to theory.

### Example 4

Example 4 demonstrates the unexpected ability to adjust the viscosity of a fluoropolymer dispersion composition by adding an aqueous additive composition that included water.

These fluoropolymer dispersion compositions were prepared by combining PVF dispersion 44-1010 with propylene carbonate (45 wt % of propylene carbonate, based on the total weight of the PVF dispersion). Different amounts of water were added to the fluoropolymer dispersion compositions to provide the various amounts of water in the final fluoropolymer dispersion compositions, as shown in Table 6.

The viscosity of the mixture was measured using Brookfield viscometer using spindle #4 at various spindle speeds (0.3, 0.6, 1, 5, 10, 100 rpm, as specified in Table 6). The thixotropy was calculated as the ratio of the viscosity at 1 rpm to the viscosity at 100 rpm. The viscosity is reported as centipoise (cPs).

TABLE 6

| water | | | | | | | | Thixotropy |
|---|---|---|---|---|---|---|---|---|
| (wt %) | 0.3 rpm | 0.6 rpm | 1 rpm | 5 rpm | 10 rpm | 50 rpm | 100 rpm | (1/100 rpm) |
| 0% | 311000 | 155000 | 96200 | 21840 | 11660 | 2884 | 1662 | 57.88 |
| 1% | 179000 | 94000 | 59600 | 13760 | 7520 | 2048 | 1204 | 49.50 |
| 2% | 121000 | 66333 | 43200 | 10480 | 5860 | 1652 | 998 | 43.29 |
| 3% | 95333 | 51333 | 34600 | 8880 | 5060 | 1448 | 878 | 39.41 |
| 4% | 91333 | 56667 | 33400 | 8440 | 4780 | 1376 | 830 | 40.24 |
| 5% | 115000 | 62667 | 39400 | 9560 | 5340 | 1516 | 912 | 43.20 |
| 10% | 145000 | 76667 | 49200 | 11840 | 6600 | 1900 | 1142 | 43.08 |

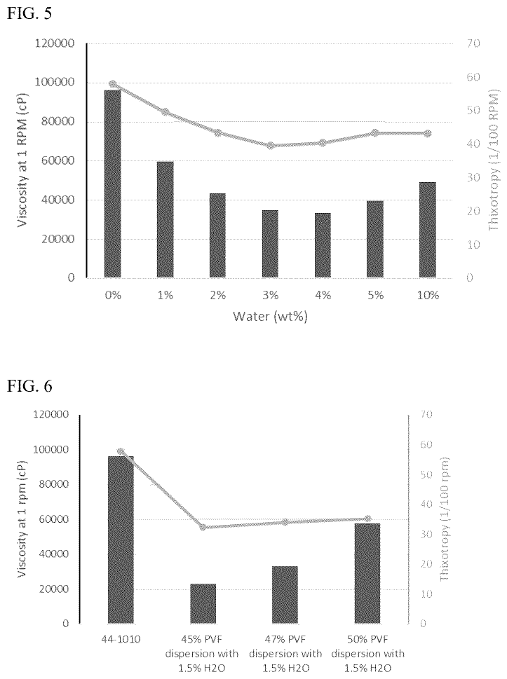

As shown in Table 6 and depicted in FIG. 5, the viscosity of PVF dispersions decreased with water increasing from 0 wt % to 4 wt %, and the viscosity increased when greater than 4 wt % of water was added to the fluoropolymer dispersion compositions. Moreover, the thixotropy did not decrease monotonically, but rather increased when more than 4 wt % of water was added. These results showed again that the decrease in viscosity and thixotropy was not a simple dilution effect because these parameters did not continuously decrease with increasing water content.

### Example 5

Example 5 demonstrates the unexpected ability to adjust the viscosity of a fluoropolymer dispersion composition by adding an aqueous additive composition that included water, where the concentration of the PVF dispersion increases without losing the observed improvements in viscosity.

These fluoropolymer dispersion compositions were prepared by combining the noted amount of the PVF dispersion 44-1010 with propylene carbonate (PC), as provided in Table 7. Water was added to each fluoropolymer dispersion composition to achieve 1.5 wt %, based on the total weight of the fluoropolymer dispersion compositions The viscosity of the mixture was measured using Brookfield viscometer using spindle #4 at various spindle speeds (1, 5, 10, 100 rpm, as specified in Table 7). The thixotropy was calculated as the ratio of the viscosity at 1 rpm to the viscosity at 100 rpm. The viscosity is reported as centipoise (cPs).

TABLE 7

| | | | | | | | | Thixot- |
|---|---|---|---|---|---|---|---|---|
| | | | | | | | | ropy |
| PC | water | PVF | 1 | 5 | 10 | 50 | 100 | (1/100 |
| wt % | wt % | wt % | rpm | rpm | rpm | rpm | rpm | rpm) |
| 55 | 0 | 45.0 | 96200 | 21840 | 11660 | 2884 | 1662 | 57.88 |
| 53.4 | 1.5 | 45.0 | 23000 | 6080 | 3540 | 1112 | 712 | 32.30 |
| 51.3 | 1.5 | 47.0 | 33000 | 8680 | 5040 | 1556 | 970 | 34.02 |
| 48.4 | 1.5 | 50.0 | 57600 | 14920 | 8680 | 2636 | 1634 | 35.25 |

As shown in Table 7 and depicted in FIG. 6, the PVF dispersion with 1.5 wt % water achieved a higher than 45 wt % PVF loading, compared with the commercially available topcoat 44-1010 (including 45 wt % of PVF). Notably, the 50 wt % PVF dispersion achieved a less viscous solution and a lower thixotropy than was obtained using the commercially available topcoat 44-1010.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A fluoropolymer dispersion composition, comprising:
a fluoropolymer comprising a poly(vinyl fluoride) homopolymer or a poly(vinyl fluoride) copolymer;
a latent solvent; and
0.05 wt % to 10 wt % of an aqueous additive composition, based on the total weight of the fluoropolymer dispersion composition,
wherein the fluoropolymer dispersion composition has a viscosity at 25° C. that is less than a viscosity at 25° C. of a comparable fluoropolymer dispersion composition that comprises the fluoropolymer and the latent solvent, wherein the comparable fluoropolymer dispersion composition does not comprise the aqueous additive composition.

2. The composition of claim 1, wherein the composition has a thixotropy at 25° C. that is less than a thixotropy at 25° C. of a comparable fluoropolymer dispersion composition that comprises the fluoropolymer and the latent solvent, wherein the comparable fluoropolymer dispersion composition does not comprise the aqueous additive composition.

3. The composition of claim 1, wherein the fluoropolymer dispersion composition comprises:
30 wt % to 60 wt % of the fluoropolymer;
40 wt % to 70 wt % of the latent solvent; and
0.1 wt % to 5 wt % of the aqueous additive composition,
wherein each amount is based on the total weight of the fluoropolymer dispersion composition.

4. The composition of claim 1, wherein the fluoropolymer comprises at least 60 mol % of vinyl fluoride repeating units, based on 100 mol % of total repeating units of the fluoropolymer.

5. The composition of claim 1, wherein the latent solvent comprises at least one of propylene carbonate, γ-butyrolactone, n-methyl pyrrolidone, dimethylacetamide, dimethylsulfoxide, isophorone, diethyl phthalate, dimethyl phthalate, dimethylformamide, or a combination of two or more of propylene carbonate, γ-butyrolactone, n-methyl pyrrolidone, dimethylacetamide, dimethylsulfoxide, isophorone, diethyl phthalate, dimethyl phthalate, and dimethylformamide.

6. The composition of claim 1, wherein the aqueous additive composition comprises water.

7. The composition of claim 6, wherein the aqueous additive composition further comprises a buffer, or wherein the fluoropolymer dispersion composition has a pH of 2 to 12.

8. The composition of claim 7, wherein the buffer comprises a citrate salt, a phosphate salt, an acetate salt, a bicarbonate salt, boric acid, a borate salt, or a combination of two or more of a citrate salt, a phosphate salt, an acetate salt, a bicarbonate salt, boric acid, and a borate salt.

9. The composition of claim 1, wherein the fluoropolymer dispersion composition has a viscosity that is 10% to 70% less than the viscosity at 25° C. of the comparable fluoropolymer dispersion composition.

10. The composition of claim 1, further comprising a coating additive composition.

11. The composition of claim 10, wherein the coating additive composition comprises:
1 wt % to 50 wt % of a pigment;
0.1 wt % to 50 wt % of a polymer;
0.1 wt % to 5 wt % of an additional additive comprising at least one of a thermal stabilizer, a light stabilizer, a flow agent, a cross-linking agent, or a leveling agent; and
optionally 0.1 to 5 wt % of water, a solvent, or a combination of two or more of water and a solvent;
wherein each amount is based on the total weight of the coating additive composition.

12. The composition of claim 11, wherein the pigment is an organic pigment or an inorganic pigment, preferably wherein the organic pigment comprises a phthalate, and preferably wherein the inorganic pigment comprises titanium dioxide, an iron oxide, zinc oxide, silica, alumina, barium sulfate, talc, mica, kaolin, or a combination of two or more of a phthalate, titanium dioxide, an iron oxide, zinc oxide, silica, alumina, barium sulfate, talc, mica, and kaolin.

13. The composition of claim 11, wherein the polymer comprises an acrylic, a polyester, a silicone modified polyester, a polyurethane, or a combination of two or more of an acrylic, a polyester, a silicone modified polyester, and a polyurethane.

14. The composition of claim 11, wherein the coating additive composition comprises the thermal stabilizer.

15. The composition of claim 11, wherein the coating additive composition comprises the light stabilizer.

16. The composition of claim 11, wherein the coating additive composition comprises the crosslinking agent.

17. A coated substrate, comprising the composition of claim 1 disposed on at least a portion of a surface of a substrate.

18. The coated substrate of claim 17, wherein the disposed composition is cured.

19. The coated substrate of claim 17, wherein the coated substrate is a metal pipe, a metal architectural unit, an architectural fabric, a polymer film, a metal sheet, or a metal coil.

20. A cured film derived from the coated substrate of claim 17, wherein the cured film is prepared by casting the fluoropolymer coating composition on the substrate, heating the composition to form the cured film, and removing the cured film from the substrate.

21. The cured film of claim 20, wherein the substrate is a polymer film.

22. The cured film of claim 20, wherein the cured film is a free-standing film.
